(19) United States
(12) Patent Application Publication
(10) Pub. No.: US 2002/0192009 A1
(43) Pub. Date: Dec. 19, 2002

(54) Memory pen device

(76) Inventor: Raja Singh Tuli, Montreal (CA)

Correspondence Address: RAJA SINGH TULI, 555 Rene Levesque West, Suite 1130, MONTREAL, QC, H2Z 1B1, CA

(21) Appl. No.: 09/879,930

(22) Filed: Jun. 14, 2001

(51) Int. Cl. B43K 29/00; B43K 23/12

(52) U.S. Cl. 401/195; 401/243

(57) ABSTRACT

The invention relates to a writing device capable of electronically recording what was written. A pen body comprising microelectronics, an acoustic emitter, an electromagnetic sensor, and a writing tip with ink reservoir is featured. A detachable cap also contains microelectronics, multiple acoustic sensors, and an electromagnetic emitter. Microelectronics in the cap determines the distance of the acoustic emitter in the pen body to multiple acoustic sensors, and by triangulation can determine the exact distance of the acoustic emitter located near the writing tip. Electromagnetic emitters and sensors are used to synchronize microelectronics with the sending times of each acoustic pulse. The exact distance of the acoustic emitter is also determined without electromagnetic emitters and sensors, by the difference in phase or timing of each pulse of acoustic signals, at two or more acoustic sensors. A computer may be used to generate a two-dimensional image map of what was written.

### BACKGROUND OF THE INVENTION

Field of the Invention

The invention relates to a pen which writes like other pens, but also contains micro electronics and emits acoustic signals which are received by multiple acoustic sensors in the cap. The cap also contains micro electronics and memory to store data received on what was written, and also to calculate the exact location of the pen tip based on the phase difference of signals received by two or more sensors.

The exact location of the pen tip is also calculated by triangulation methods of the distance between two or more acoustic sensors in the cap.

### SUMMARY OF THE INVENTION

The present invention relates to a portable writing instrument, which is capable of electronically storing information on what was written.

The pen consists of a cap, which functions in the opened position as a receiving and storage device for acoustic signals, and also as an electromagnetic transmitter. The pen body contains a pressure transducer, which detects when pressure is applied to the writing tip and converts any applied pressure on the writing tip to an electronic signal. Applied pressure on the writing tip is detected by the transducer, which sends a signal to the microelectronics in the pen body. The microelectronics in the pen body is also connected to a sound emitter which is located close to the writing tip. The pen body also contains an electromagnetic sensor capable of detecting electromagnetic waves, which is also connected to the microelectronics in the pen body. The cap contains microelectronics and multiple acoustic sensors, with an electromagnetic emitter.

Thus, when the user removes the cap and places it in front the pen body and applies a pressure on the tip to write, the pen sends pulses of acoustic signals towards the cap. The cap receives these acoustic signals, and commences an initialization process by sending electromagnetic pulses at a constant interval. The pen body responds by sending an acoustic pulse at a fixed time after receiving each electromagnetic pulse. Since electromagnetic waves travel much faster than acoustic waves, the microelectronics can determine the distance of each acoustic sensor in the cap to the acoustic emitter near the writing tip, for each pulse, based on the speed of acoustic waves and time taken to receive each acoustic pulse at each acoustic sensor. Triangulation is used to determine the exact location of the acoustic emitter near the writing tip, for each acoustic pulse.

Another embodiment involves the cap sending a single electromagnetic pulse, upon receiving a first pulse of acoustic signals from the pen body. Upon receiving this electromagnetic pulse, the pen body transmits pulses of acoustic signals at a constant time interval. Knowing this time interval, the microelectronics in the cap can determine the start time of each pulse of acoustic signals and time taken to receive each acoustic pulse at each acoustic sensor. Triangulation is again used to determine the exact location of the acoustic emitter near the writing tip, for each acoustic pulse.

A further embodiment does not incorporate electromagnetic sensors or emitters, but simply uses the difference in phase or timing of two or more acoustic sensors, for each pulse of acoustic signals, to determine the exact location of the acoustic emitter near the writing tip.

Information stored in the cap may be subsequently down loaded to a computer, which generates a two dimensional image map of what was written, and stores this into memory.

### BRIEF DESCRIPTION OF THE DRAWINGS

The invention is described in more detail below with respect to an illustrative embodiment shown in the accompanying drawings in which:

FIG. 1 illustrates the pen body with the cap attached in the closed position, in accordance with the present invention.

FIG. 2 illustrates the cap detached from the pen body, in accordance with the present invention.

FIG. 3 illustrates the pen with cap in the opened position, whereby the cap contains two acoustic sensors for demonstration purposes, in accordance with the present invention.

FIG. 4 illustrates the phase difference between the electromagnetic signals and acoustic signals used to determine the location of the acoustic sensor near the writing tip, in accordance with the present invention.

FIG. 5 illustrates the pen with cap in the opened position, whereby the cap contains multiple acoustic sensors, in accordance with the present invention.

FIG. 6 illustrates the cap of the writing device interfacing with a computer to download data of what was written, in accordance with the present invention.

FIG. 7 illustrates a PDA (Personal Digital Assistant) or hand held computer used to receive the acoustic signals emitted from the pen body, and to compute, display and store into memory what was written, in accordance with the present invention.

FIG. 8 illustrates a cellular phone used to receive the acoustic signals emitted from the pen body, and to compute, display and store into memory what was written, in accordance with the present invention.

FIG. 9 illustrates a cellular phone used to receive radio frequency signals emitted from the pen body, and to compute, display and store into memory what was written, in accordance with the present invention.

FIG. 10 illustrates the pen with cap in the opened position, whereby the cap contains multiple acoustic sensors without an electromagnetic emitter or sensor, in accordance with the present invention.

### DETAILED DESCRIPTION OF THE PREFERRED EMBODIMENTS

To facilitate description, any numeral identifying an element in one figure will represent the same element in any other figure.

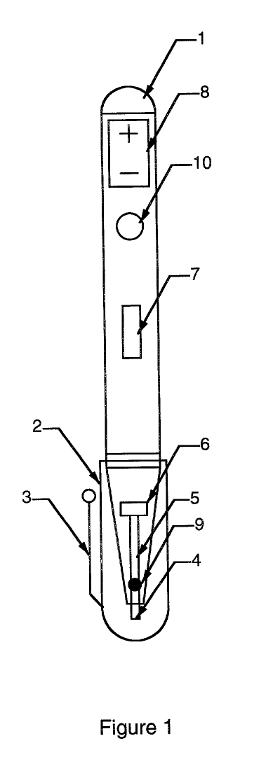

The principal embodiment of the present invention aims to provide a portable device that allows a user to write as a regular pen, with the added feature of being able to electronically store exactly what was written into a memory on the device or in a computer. The pen consists of a pen body 1 and a cap 2 as illustrated in the closed position of FIG. 1. The cap 2 is comprised of a clip 3, which functions to secure the pen to a shirt pocket, clipboard or other articles with the cap in the closed position fastened to the pen body. The cap 2 also functions in its closed position fastened to the pen body to keep the writing tip 4 of the pen protected from accidentally touching clothing or other articles, and keeps air away from the writing tip allowing ink in the reservoir 5 that flows to the writing tip to last longer. The cap functions in the opened position as a receiving and storage device for acoustic signals, and also as an electromagnetic transmitter as explained later on. The pen body 1 contains a pressure transducer 6, which detects when pressure is applied to the writing tip 4 and converts any applied pressure on the writing tip to an electronic signal, which is directed to microelectronics 7, powered by a battery 8 located in the pen body. The magnitude of applied pressure on the writing tip, which is detected by the transducer 6 is also sent to the microelectronics 7. The microelectronics 7 is also connected to a sound emitter 9 which is located close to the writing tip 4 on the pen body 1. The pen body 1 also contains an electromagnetic sensor 10 capable of detecting electromagnetic waves, which is also connected to the microelectronics 7 in the pen body.

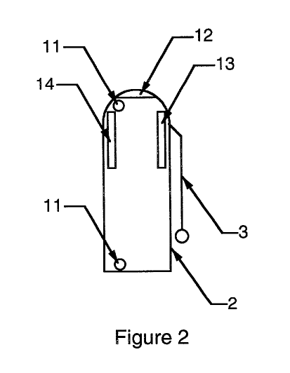

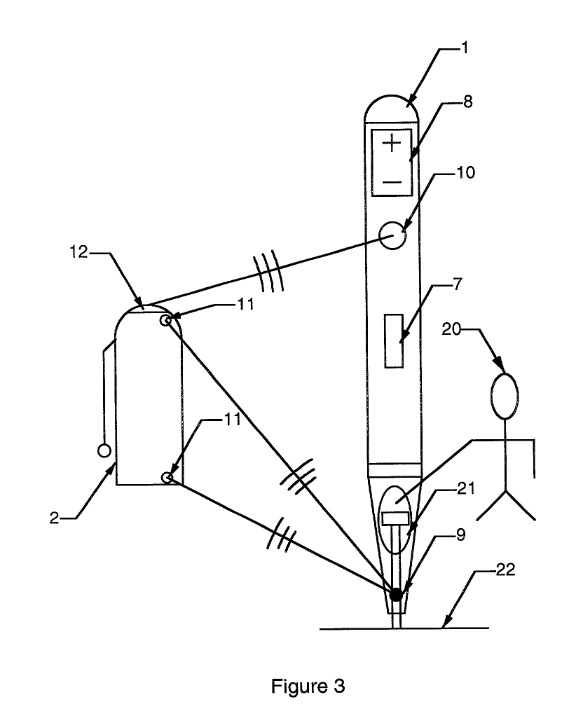

For demonstration purposes and with further reference to FIG. 2, the cap 2 contains two acoustic sensors 11 at a fixed distance apart, connected to another independent set of microelectronics 13 located in the cap, powered by batteries 14. The cap also contains an electromagnetic emitter 12, which is connected to the microelectronics 13 in the cap. With further reference to FIG. 3, when the cap is removed and placed in a stationary position in front of the user 20 and also in front of the pen body 1, the sound emitter 9 on the pen body is located such that it points in the general direction towards the cap 2, when held in a manner to write with by the user. Contours 21 in the pen body 1 facilitate such a holding manner with the sound emitter 9 pointing away from the user 20, minimizing the risk of reflected acoustic signals from the user which would interfere with detection at both acoustic sensors 11 on the cap.

In accordance with the principal embodiment of the invention with reference to FIG. 3, when the user applies a pressure on any writing surface 22 with the writing tip 4, the transducer 6 acts as a pressure sensor or trigger and sends a signal to the microelectronics 7 informing that the writing process is about to start. The microelectronics 7 responds immediately by repetitively sending pulses of acoustic signals of a short duration at equal time intervals, via the sound emitter 9 in the pen body 1 to the cap 2, until the cap sends an acknowledgement of receiving its first acoustic pulse. Upon receiving a first acoustic pulse at the two acoustic sensors 11 in the cap, the initialization process is completed and the cap responds by sending multiple electromagnetic pulses at a constant time interval, at a fixed time after the first acoustic pulse is received. The electromagnetic sensor 10 in the pen body receives these electromagnetic pulses from the cap, and upon receiving the first electromagnetic pulse, the pen body stops repetitively sending pulses of acoustic signals acknowledging completion of the initialization process. The pen body immediately sends an acoustic pulse of a short duration in response to each subsequent electromagnetic pulse from the cap, for the duration of pressure applied on the writing tip 4, which is detected by the transducer 6. As the pressure on the writing tip is removed, the pen ceases to send acoustic pulses.

The cap measures the time taken to receive the same acoustic pulse at each acoustic sensor 11, and since electromagnetic pulses travel very fast compared to acoustic pulses, the microelectronics 13 can calculate the distance of the pen body from each acoustic sensor in the cap for each acoustic pulse. Based on the speed of acoustic pulses and the time delay between sending the electromagnetic pulse and receiving the acoustic pulse at each acoustic sensor, the microelectronics 13 in the cap can determine this distance of the pen body from each acoustic sensor. By triangulation with the distance between each acoustic sensor 11 in the cap, the microelectronics 13 in the cap can calculate the exact position or point of the emitter 9 near the writing tip 4, and this point data is stored into memory in the cap for each acoustic pulse emitted by the pen, whereby the point data is relative to the cap itself. This calculation is done for each emitted acoustic pulse from the pen body, and the point data is stored in the cap.

In accordance with a second embodiment of the invention and with reference to FIG. 3, when the user applies a pressure on any writing surface 22 with the writing tip 4, the transducer 6 acts as a pressure sensor or trigger and sends a signal to the microelectronics 7 informing that the writing process is about to start. The microelectronics 7 responds immediately by repetitively sending pulses of acoustic signals of a short duration at equal time intervals, via the sound emitter 9 in the pen body 1 to the cap 2, until the cap sends an acknowledgement of receiving its first acoustic pulse. Upon receiving a first acoustic pulse at the two acoustic sensors 11 in the cap, the initialization process is completed and the cap responds by sending an electromagnetic pulse at a fixed time after the first acoustic pulse is received, via the electromagnetic emitter 12 located in the cap. The electromagnetic sensor 10 in the pen body receives this electromagnetic pulse from the cap, and the pen body stops repetitively sending pulses of acoustic signals acknowledging completion of the initialization process. Hence, the cap is aware that writing is about to proceed and is awaiting information from the pen body, and the pen body has received confirmation from the cap via the electromagnetic pulse received that the cap is ready to receive data. A short while after or immediately after receiving this electromagnetic pulse from the cap, the pen body proceeds to send pulses of acoustic signals at a constant time interval from the sound emitter 9, for the duration of pressure applied on the writing tip. Hence, the cap can determine when each acoustic pulse is emitted from the pen body, since it knows when the electromagnetic pulse was sent, and it knows the duration of time after the electromagnetic pulse that the pen body is designed to send these acoustic pulses, at a constant time interval. The cap also knows this constant time interval. This is essential, as the cap must know the starting time of each acoustic pulse before it arrives and is detected at the cap. Thus the cap can measure the time taken between transmitting at the pen body and receiving at the cap for the same acoustic pulse at each acoustic sensor 11, for each transmitted acoustic pulse. Since electromagnetic pulses travel very fast compared to acoustic pulses, the microelectronics 13 can calculate the distance of the pen body from each acoustic sensor in the cap for each acoustic pulse. Based on the speed of acoustic pulses and the time delay between sending the electromagnetic pulse and receiving the acoustic pulse at each acoustic sensor, the microelectronics 13 in the cap can determine this distance of the pen body from each acoustic sensor. By triangulation with distance of the pen body from each acoustic sensor and the distance between each acoustic sensor in the cap, the microelectronics 13 in the cap can calculate the exact position or point of the emitter 9 near the writing tip 4, and this point data is stored into memory in the cap for each acoustic pulse emitted by the pen, whereby the point data is relative to the cap itself. This calculation is done for each emitted acoustic pulse from the pen body, and the point data is stored in the cap.

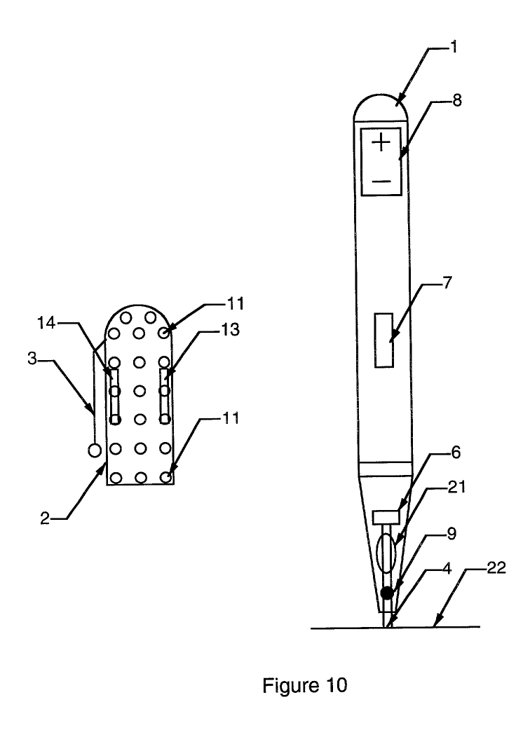

In accordance with a third embodiment of the invention and FIG. 10, the cap 2 contains multiple acoustic detectors 11 located all around it. The cap also contains microelectronics 13 powered by batteries 14. However, the cap does not contain an electromagnetic emitter and the pen body does not contain an electromagnetic sensor, as this is not required in this particular embodiment. When the user applies a pressure on any writing surface 22 with the writing tip 4, the transducer 6 acts as a pressure sensor or trigger and sends a signal to the microelectronics 7 informing that the writing process is about to start. The microelectronics 7 responds immediately by repetitively sending pulses of acoustic signals of a short duration at equal time intervals, via the sound emitter 9 in the pen body 1 to the cap 2. Upon receiving each acoustic pulse at the acoustic sensors 11 in the cap, the microelectronics in the cap knows the relative amount of time taken to receive the same acoustic pulse at each acoustic detector in the cap. The microelectronics does not know the absolute distance between the pen body and cap, but since it knows the difference in time taken to receive the same acoustic pulse between more than two acoustic detectors 11, the position of the pen relative to the cap can be determined for each acoustic pulse sent from the pen body. Since there are multiple detectors, the microelectronics knows the relative difference between the phase or timing of those acoustic pulses from the pen body, as the same pulse may take a shorter or longer time to reach each sensor in the cap. The cap stores into memory the phase or timing difference between each acoustic detector 11 for each acoustic pulse. The difference in the phase or timing of more than two acoustic detectors for the same pulse can give the exact position or point data of the pen's sound emitter 9 near the writing tip 4 relative to the cap, for each acoustic pulse. This calculation of the exact position or point data for each acoustic pulse may be done by the microelectronics 13 in the cap and the point data stored in the cap, or this calculation may be done after the phase difference for each point data stored in the cap is downloaded into a computer, and the computer calculates the point data, as will be explained later on.

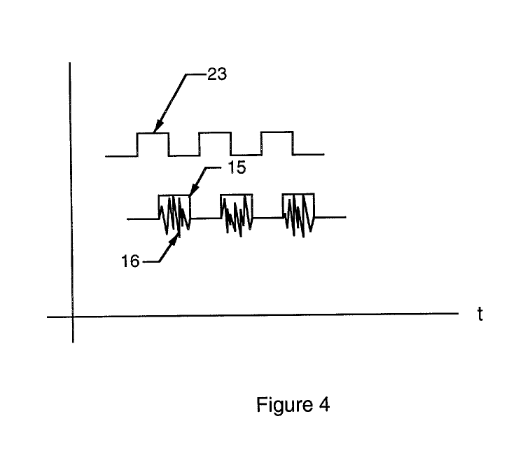

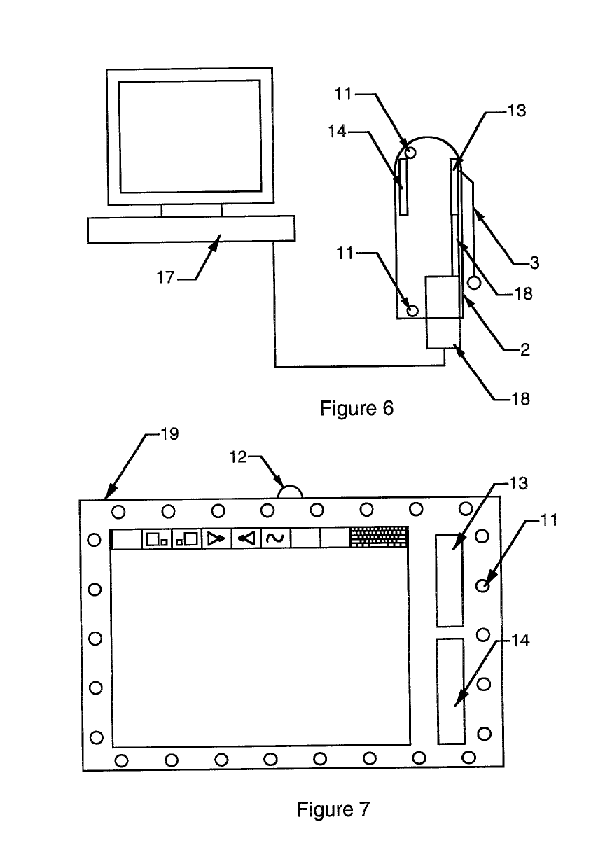

With further reference to FIG. 4, and with embodiments containing an electromagnetic emitter in the cap, as soon as the pen body detects the electromagnetic pulse 23 from the cap, it immediately sends another acoustic pulse 15 consisting of sound waves 16. Thus there is a time delay between the sending of the electromagnetic pulse and receiving the acoustic pulse 15 at the cap, as illustrated. In all embodiments, when pressure is removed from the transducer 6 by the user lifting the pen body's writing tip 4 away from the writing surface, the pen body ceases to transmit acoustic pulses 15, as this conserves on battery power consumption. Both the pen body 1 and cap 2 go into a sleep mode to further conserve on battery power when acoustic pulses are not being transmitted by the pen body, whereby the microelectronics in both pen body and cap are powered down awaiting a start up signal from the pressure transducer 6. Batteries 8 & 14 are located in both the pen body and the cap to power respective microelectronics 7 & 13 contained within. Memory is contained within the microelectronics 13 of the cap, but none is required in the pen body as no data is stored there. As the user writes with the pen body, ink from the reservoir 5 is transferred to the writing surface 22, and the microelectronics 13 of the cap stores into memory the point data of what has been written. The cap stores point data for each acoustic pulse in a compressed format in the microelectronics 13, and transmits this point data to an external computer 17 via an interface 18, as illustrated in FIG. 6. The cap contains sufficient memory to store written documents in the form of point data when the device is mobile, and at a later time the cap may be interfaced to download all stored data to the computer, thereafter erasing occupied memory for further data storage in the cap. The computer downloads the point data stored in the cap and generates an image map of what was written by connecting the points of the point data in proper sequence, and also compiles other information such as speed of the writing tip 4, and or the amount of pressure applied to the writing tip. Each point of the point data represents a different position that the pen has moved to if the pen is in motion. The image map generated by the computer is cropped to the minimum size and stored as a file on the computer. Hence, the computer determines from the size and coordinates of the written image, absolute minimum dimensions to crop the image surrounding it without losing any portions of the image. This ensures that the minimum size of electronic file is stored in memory on the computer, for each written image. The speed of the writing tip is determined from the distance between successive points (of point data) and the time interval between these points, which is known. The acoustic pulse sent from the sound emitter 9 in the pen body 1 may also contain information on the amount of pressure exerted on the writing tip, as any pressure on the writing tip is transmitted directly to the transducer 6, which produces an electrical output proportional to the applied pressure. Information on pressure is stored in the cap for each point of the point data, and is later downloaded to the computer.

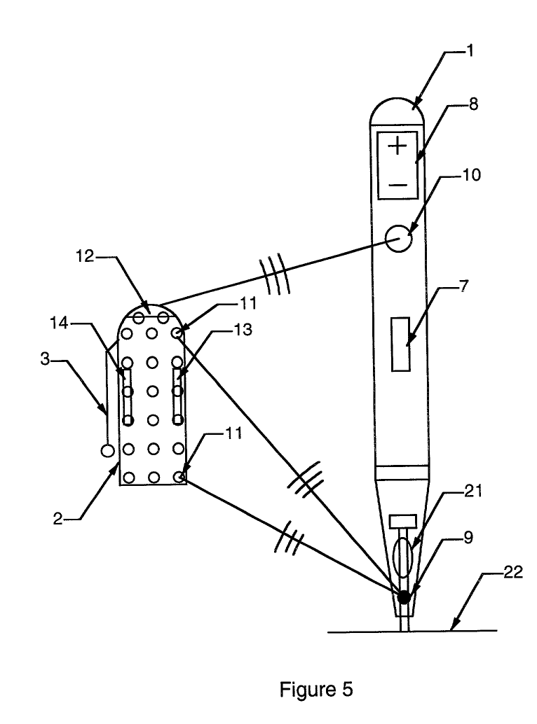

In a fourth embodiment of the present invention, with further reference to FIG. 5 and the principal and second embodiments, the cap 2 contains multiple acoustic detectors 11 all around it, instead of only two. The cap also contains microelectronics 13 powered by batteries 14, and an electromagnetic emitter 12, which is connected to microelectronics 13 in the cap. The writing device operates in a similar fashion as the principal and second embodiments, with the main difference being the multiple acoustic detectors 11, some of which receive the same acoustic pulse from the pen body 1. The microelectronics in the cap knows the start time of each acoustic pulse and time taken to receive the same acoustic pulse, at those acoustic detectors in the cap which are strategically positioned in the line of sight of the sound emitter 9. When the user takes the cap off the pen body and places it nearby, no matter what the orientation of the cap is with respect to the pen body, there is still some portion of the cap which will face the pen body containing two or more acoustic sensors, which are used in triangulating the location of the pen body. This is, in fact, the purpose of having multiple acoustic sensors as the position and angular orientation of the cap is indeterminate with respect to the pen body. Since there are multiple acoustic detectors 11 positioned all around the cap, there are always some acoustic detectors in the line of sight of the sound emitter on the pen body. However, only a few of these acoustic detectors in the line of sight of the sound emitter may be useful in triangulating and computing the point data, as some detectors may be located such that they do not have a difference in distance from the sound emitter with each other, and can not be used in triangulation. Thus, the cap measures the time taken to receive the same acoustic pulse at each acoustic sensor 11 in the line of sight of the sound emitter, and since electromagnetic pulses travel very fast compared to acoustic pulses, the microelectronics 13 in the cap can calculate the distance of the pen body from each acoustic sensor in the cap, for each acoustic pulse. The microelectronics 13 in the cap would decide which data to use from acoustic sensors that are the best or optimally positioned for calculating the point data. This calculation is done by the microelectronics 13 in the cap for each emitted acoustic pulse from the pen body, and the point data is stored in the cap and may be down loaded to a computer at a later time, when the pen is no longer mobile. Alternatively, the cap measures the time taken to receive the same acoustic pulse at each acoustic sensor 11 in the line of sight of the sound emitter, and stores this data into memory. After this data is downloaded to a computer, the computer would decide which data to use from acoustic sensors that are the best or optimally positioned for calculating the point data. The point data calculated for each acoustic pulse is three-dimensional as data from multiple acoustic sensors is used, so the computer must determine the plane of the image and translate the point data into a two-dimensional image. The point data is three-dimensional because the cap may not be in the same plane as the writing surface, thus it may be higher or lower or offset at indeterminate angular orientations from the plane of the writing surface. Hence, the image that is written on the writing surface 22 is three-dimensional with respect to the multiple acoustic sensors in the cap, as these multiple acoustic sensors hold an indeterminate plane with respect to the writing surface. Another advantage of having more than two acoustic sensors in the line of sight to the pen body, is for the cap to be able to store multiple points of data for the same point, thus enabling a better resolution minimizing any errors in computing the precise location of each point, thereby improving the accuracy in calculating point data. The computer then crops the two-dimensional image to a minimum size and stores it as a file, and may display for view at any time.

In a fifth embodiment of the invention in accordance with the fourth embodiment, the cap stores the time taken for the same acoustic pulse to reach a certain sub-set of acoustic detectors 11 of the multiple acoustic detectors present in the cap, for each acoustic pulse sent from the pen body. The microelectronics 13 in the cap determines which of the multiple acoustic detectors to use in this sub-set that are optimum for triangulation, from the signals received at acoustic detectors in the line of sight of the sound emitter, as the orientation of the cap is indeterminate with respect to the pen body. There are two basic ways used in conjunction in which the microelectronics 13 determines which acoustic detectors are to be used. The first way is to select acoustic detectors having the strongest signals. Another way is to select acoustic signals having reasonable signal strengths, determined by preset parameters, and also optimally suited for triangulation. One method of being best suited for triangulation is to be furthest apart. The data stored in the cap is subsequently downloaded via the interface 18 to the computer, which further translates the point data into a two-dimensional image.

In a sixth embodiment of the present invention in accordance with FIG. 7 and the third and fourth embodiments, multiple acoustic detectors 11 are located on a PDA (Personal Digital Assistant) 19 or similar hand held device. The microelectronics 13, battery source 14, and the electromagnetic emitter 12 previously located on the cap are all located on the PDA (Personal Digital Assistant) 19 or similar hand held computer device. As the user writes with the pen, the device 19 receives acoustic pulses and calculates the pen location for each acoustic pulse emitted by the pen body as in the fourth and fifth embodiments, displays what was written and stores this as a file in memory on the PDA 19 or similar hand held device.

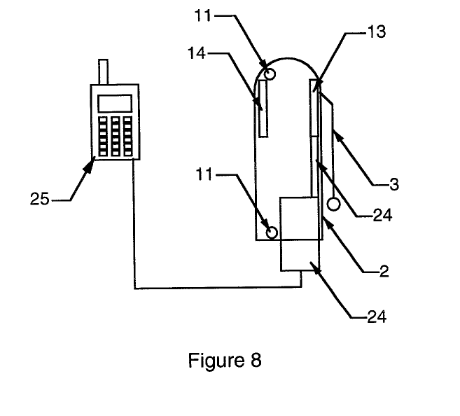

In accordance with FIG. 8 and a seventh embodiment of the present invention, the cap may interface with a cellular phone 25 to transfer data stored in the cap to a web site. This is done via an interface 24 to the cap, and the communication with the cellular phone may be hard wired or wireless. The cap receives and stores data in accordance with previous embodiments. The computer that accesses this web site where data in the cap is transferred to, would perform the calculating of the three-dimensional point data and the plane of the image, to further translate the point data into a two-dimensional image.

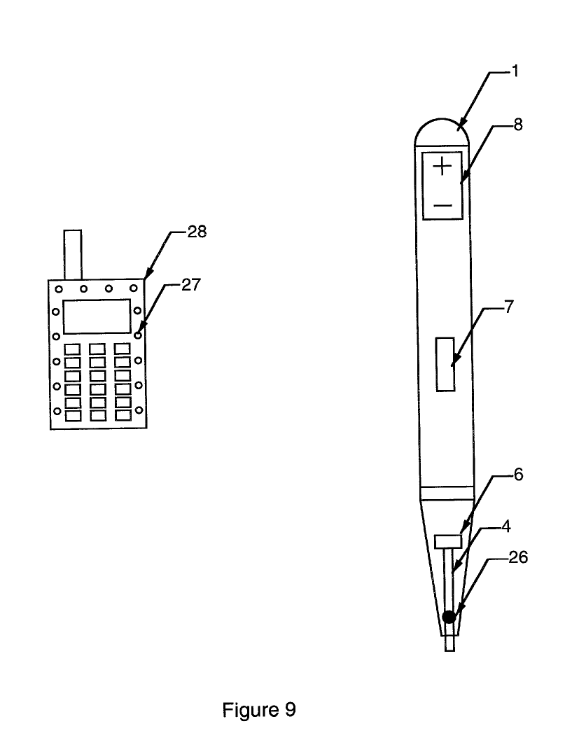

In accordance with FIG. 9 and an eighth embodiment of the present invention, multiple radio frequency detectors 27 are located on a cellular telephone 28. The pen body 1 contains a pressure transducer 6, which detects when pressure is applied to the writing tip 4 and converts any applied pressure on the writing tip to an electronic signal, which is directed to microelectronics 7, powered by a battery 8 located in the pen body. The magnitude of applied pressure on the writing tip, which is detected by the transducer 6 is also sent as an electronic signal to the microelectronics 7. The microelectronics 7 is also connected to a radio frequency transmitter 26 which is located close to the writing tip 4 on the pen body 1. As the user writes with the pen by applying pressure on the writing tip, the microelectronics 7 detects this pressure via a signal from the transducer 6, and the radio frequency transmitter 26 on the pen body immediately transmits radio frequency pulses at a constant time interval. The cellular phone 28 receives radio frequency signals from the radio frequency transmitter 26 on the pen body, and calculates the location of the transmitter near the writing tip of the pen body which is the point data, based on the timing or phase differences of the same signal received at a few radio frequency detectors 27. Microelectronics in the cellular phone may determine which signals from each detector are best suited for calculating the location of the pen body based on the signal quality received. The cellular phone stores point data as in previous embodiments for each radio frequency pulse. Thus, microelectronics in the cellular phone 28 calculates the pen location for each radio frequency pulse emitted by the pen body, displays what was written and stores this as a file in memory on the cellular phone.

I claim:

1. A writing device comprising a main body and a cap, whereby the main body contains an acoustic emitter which produces pulses of acoustic signals, located on the main body near the writing tip such that, when a user holds a plurality of contours along the main body, the acoustic emitter always points in a direction away from the user towards the cap.

2. A writing device such that:
a main body contains a writing tip at one end fed with ink from a reservoir, which is protected by a cap that temporarily attaches onto the main body in a closed position, whereby said cap contains a clip at one end to fasten the attached main body to another article;
an acoustic emitter produces pulses of acoustic signals located on the main body near the writing tip;
a plurality of acoustic detectors located on the cap can each detect acoustic signals from said acoustic emitter;
an electromagnetic emitter is located on the cap whereby an electromagnetic sensor located on the main body detects electromagnetic waves from the electromagnetic emitter;
microelectronics are located in the cap and in the pen body;
a pressure transducer is connected to the writing tip on the main body whereby upon detaching the cap from the main body and placing in front the user and applying a force to the writing tip, said pressure transducer sends a signal to the microelectronics in the main body;
microelectronics in the cap instructs multiple electromagnetic pulses sent at a constant time interval;
in response to receiving electromagnetic pulses, the main body sends acoustic pulses of a short duration at a fixed time after each subsequent electromagnetic pulse;
microelectronics in the cap measures the time taken to receive the same pulse of acoustic signals at many acoustic sensors, for each pulse of acoustic signals, from the time each electromagnetic pulse is sent, whereby the distance of each acoustic sensor to the acoustic emitter is determined;
microelectronics in the cap determines by triangulation the exact position of the acoustic emitter near the writing tip for each pulse of acoustic signals, which is stored as compressed data in the microelectronics of the cap.

3. A device as claimed in claim 2 such that data stored in the microelectronics of the cap is subsequently downloaded to a computer utilizing an interface, whereby said computer generates a two dimensional image map cropped to a minimum size and stored in memory.

4. A writing device such that:
a main body contains a writing tip at one end fed with ink from a reservoir, which is protected by a cap that temporarily attaches onto the main body in a closed position, whereby said cap contains a clip at one end to fasten the attached main body to another article;
an acoustic emitter located on the main body near the writing tip produces pulses of acoustic signals;
a plurality of acoustic detectors is located on the cap which can each detect acoustic signals from said acoustic emitter;
an electromagnetic emitter is located on the cap whereby an electromagnetic sensor located on the main body detects electromagnetic waves from the electromagnetic emitter;
microelectronics are located in the cap and in the pen body;
a pressure transducer is connected to the writing tip on the main body whereby upon detaching the cap from the main body and placing in front the user and applying a force to the writing tip, said pressure transducer sends a signal to the microelectronics in the main body;
microelectronics in the cap sends a single electromagnetic pulse;
in response to receiving the electromagnetic pulse, the main body sends acoustic pulses of a short duration at a constant time interval thereafter;
microelectronics in the cap measures the time taken to receive the same pulse of acoustic signals at many acoustic sensors, for each acoustic pulse, from the time the electromagnetic pulse was initially sent, whereby the distance of each acoustic sensor to the acoustic emitter is determined;
microelectronics in the cap determines by triangulation the exact position of the acoustic emitter near the writing tip for each pulse of acoustic signals, which is stored as compressed data in the microelectronics of the cap.

5. A device as claimed in claim 4 such that data stored in the microelectronics of the cap is subsequently downloaded to a computer utilizing an interface, whereby said computer generates a two dimensional image map cropped to a minimum size and stored in memory.

6. A writing device such that:
a main body contains a writing tip at one end fed with ink from a reservoir, which is protected by a cap that temporarily attaches onto the main body in a closed position, whereby said cap contains a clip at one end to fasten the attached main body to another article;
an acoustic emitter located on the main body near the writing tip produces pulses of acoustic signals;
a plurality of acoustic detectors located on the cap can each detect acoustic signals from said acoustic emitter;
microelectronics are located in the cap and in the pen body;
a pressure transducer is connected to the writing tip on the main body whereby upon removing the cap and placing in front the user and applying a force to the writing tip, said pressure transducer sends a signal to the microelectronics in the main body;
microelectronics in the cap determines the difference in phase or timing for each pulse of acoustic signals at each acoustic detector;
microelectronics in the cap stores the difference in phase or timing between acoustic detectors for each pulse of acoustic signals.

7. A device as claimed in claim 6 such that microelectronics in the cap determines by the difference in phase or timing at more than two acoustic detectors, the exact position of the acoustic emitter near the writing tip for each pulse of acoustic signals, which is stored as compressed data in the microelectronics of the cap.

8. A device as claimed in claim 6 such that data stored in the microelectronics of the cap is subsequently downloaded to a computer utilizing an interface, whereby said computer determines the exact position of the acoustic emitter near the writing tip for each pulse of acoustic signals, and generates a two dimensional image map cropped to a minimum size and stored in memory.

9. A writing device such that:
a main body contains a writing tip at one end fed with ink from a reservoir, which is protected by a cap that temporarily attaches onto the main body in a closed position, whereby said cap contains a clip at one end to fasten the attached main body to another article;
an acoustic emitter located on the main body near the writing tip produces pulses of acoustic signals;
a plurality of acoustic detectors located on a hand held computer which can each detect acoustic signals from the acoustic emitter;
an electromagnetic emitter is contained within said hand held computer device;
microelectronics are located in the hand held computer and in the pen body;
a pressure transducer is connected to the writing tip on the main body whereby upon removing the cap and placing the hand held computer in front the user and applying a force to the writing tip, said pressure transducer sends a signal to the microelectronics in the main body;
the hand held computer instructs multiple electromagnetic pulses sent at a constant time interval;
in response to receiving electromagnetic pulses, the main body sends acoustic pulse of a short duration at a fixed time after each subsequent electromagnetic pulse;
the hand held computer device measures the time taken to receive the same pulse of acoustic signals at many acoustic sensors, for each pulse of acoustic signals, from the time each electromagnetic pulse is sent, whereby the distance of each acoustic sensor to the acoustic emitter is determined;
the hand held computer device determines by triangulation the exact position of the acoustic emitter near the writing tip for each pulse of acoustic signals, which is stored as compressed data in the hand held computer, whereby said hand held computer generates a two dimensional image map cropped to a minimum size, displays to the user and stores in memory.

10. A writing device such that:
a main body contains a writing tip at one end fed with ink from a reservoir, which is protected by a cap that temporarily attaches onto the main body in a closed position, whereby said cap contains a clip at one end to fasten the attached main body to another article;
an acoustic emitter located on the main body near the writing tip produces pulses of acoustic signals;
a plurality of acoustic detectors located on a hand held computer which can each detect acoustic signals from the acoustic emitter;
an electromagnetic emitter is located on the hand held computer whereby an electromagnetic sensor located on the main body detects electromagnetic waves from the electromagnetic emitter;
microelectronics are located in the hand held computer and in the pen body;
a pressure transducer is connected to the writing tip on the main body whereby upon removing the cap and placing the hand held computer in front the user and applying a force to the writing tip, said pressure transducer sends a signal to the microelectronics in the main body;
microelectronics in the hand held computer sends a single electromagnetic pulse;
in response to receiving the electromagnetic pulse, the main body sends acoustic pulses of a short duration at a constant time interval thereafter;
microelectronics in the hand held computer measures the time taken to receive the same pulse of acoustic signals at many acoustic sensors, for each acoustic pulse, from the time the electromagnetic pulse was initially sent, whereby the distance of each acoustic sensor to the acoustic emitter is determined;
microelectronics in the hand held computer determines by triangulation the exact position of the acoustic emitter near the writing tip for each pulse of acoustic signals, which is stored as compressed data in the hand held computer, whereby said hand held computer generates a two dimensional image map cropped to a minimum size, displays to the user and stores in memory.

11. A writing device such that:
a main body contains a writing tip at one end fed with ink from a reservoir, which is protected by a cap that temporarily attaches onto the main body in a closed position, whereby said cap contains a clip at one end to fasten the attached main body to another article;
an acoustic emitter located on the main body near the writing tip produces pulses of acoustic signals;
a plurality of acoustic detectors located on a hand held computer which can each detect acoustic signals from the acoustic emitter;
microelectronics are located in the hand held computer and in the pen body;
a pressure transducer is connected to the writing tip on the main body whereby upon removing the cap and placing the hand held computer in front the user and applying a force to the writing tip, said pressure transducer sends a signal to the microelectronics in the main body;
the hand held computer determines the difference in phase or timing for each pulse of acoustic signals at each acoustic detector, whereby said hand held computer determines the exact position of the acoustic emitter near the writing tip for each pulse of acoustic signals, generates a two dimensional image map cropped to a minimum size, displays to the user and stores in memory.

12. A writing device such that:
a main body contains a writing tip at one end fed with ink from a reservoir, which is protected by a cap that temporarily attaches onto the main body in a closed position, whereby said cap contains a clip at one end to fasten the attached main body to another article;
a radio frequency emitter located on the main body near the writing tip produces pulses of radio frequency signals;
a plurality of radio frequency detectors located on a cellular phone which can each detect radio frequency signals from the radio frequency emitter;
microelectronics are located on the cellular phone and in the pen body;
a pressure transducer is connected to the writing tip on the main body whereby upon removing the cap and applying a force to the writing tip, said pressure transducer sends a signal to the microelectronics in the main body;
the cellular phone determines the difference in phase or timing for each pulse of radio frequency signals at each radio frequency detector, whereby said cellular phone determines the exact position of the radio frequency emitter near the writing tip for each pulse of radio frequency signals, generates a two dimensional image map cropped to a minimum size, displays to the user and stores in memory.
